(19) United States
(12) Patent Application Publication
(10) Pub. No.: US 2025/0284550 A1
(43) Pub. Date: Sep. 11, 2025

(54) OPTIMIZED POD PROVISIONING IN KUBERNETES AUTO-SCALER ENVIRONMENT

(71) Applicant: CAST AI Group, Inc., North Miami Beach, FL (US)

(72) Inventors: Leonid Kuperman, Toronto (CA); Kyrylo Yefimenko, Santo António da Serra (PT); Saulius Mašnauskas, Vilnius (LT)

(21) Appl. No.: 18/619,942

(22) Filed: Mar. 28, 2024

Related U.S. Application Data
(60) Provisional application No. 63/563,679, filed on Mar. 11, 2024.

(51) Int. Cl. G06F 9/50

(52) U.S. Cl. CPC G06F 9/5044

(57) ABSTRACT

A pod-pinning tool selects a Kubernetes pod to act as an arbiter pod that controls pod allocation for nodes from a plurality of candidate pods. Responsive to determining that a scaling operation is to be performed, the pod-pinning tool instructs the arbiter pod to generate a placeholder node while an assigned node is instantiated. The pod-pinning tool instructs the arbiter pod to bind one or more particular pods to the placeholder node. Responsive to determining that the assigned node is instantiated, the pod-pinning tool instructs the arbiter pod to clear the placeholder node.

### CROSS-REFERENCE TO RELATED APPLICATIONS

This application claim benefit of U.S. Provisional Application No. 63/563,679, filed Mar. 11, 2024, which is incorporated by reference in its entirety.

### TECHNICAL FIELD

The disclosure generally relates to the field of Kubernetes auto-scaling, and more particularly relates to optimized pod provisioning in an auto-scaling environment.

### BACKGROUND

Autoscalers are used to scale nodes, as well as Kubernetes pods that are provisioned to nodes, up and down depending on the dynamic needs of a service that is deployed. Autoscalers act on an abstraction layer that is detached from the Kubernetes control plane. This leads to inefficiencies, given that Autoscalers command resources be provisioned based on various factors such as cloud compute offerings, nodes that are required for workloads, cluster state, and so on, whereas the Kubernetes control plane is only aware of the current state of a given cluster without knowledge of these other various factors. This yields scenarios where the Kubernetes control plane makes decisions that do not line up with instructions from Autoscalers, ultimately resulting in inefficient pod to node allocations.

### SUMMARY

Systems and methods are disclosed herein for deploying an arbiter pod on the control plane that is responsible for optimized provisioning of nodes during autoscaling operations. In some embodiments, an autoscaler selects a Kubernetes pod to act as an arbiter pod that controls pod allocation for nodes from a plurality of candidate pods. Responsive to determining that a scaling operation is to be performed, the autoscaler instructs the arbiter pod to generate a placeholder node while an assigned node is instantiated. The autoscaler instructs the arbiter pod to bind one or more particular pods to the placeholder node, and, responsive to determining that the assigned node is instantiated, the autoscaler instructs the arbiter pod to clear the placeholder node.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for deploying an autoscaler.

FIG. 2 illustrates one embodiment of exemplary modules used by the autoscaler.

FIG. 3 illustrates one embodiment of a swim lane diagram showing activities taken by the autoscaler and an arbiter pod.

FIG. 4 illustrates an exemplary flowchart for activities performed by the autoscaler in optimally provisioning pods to nodes.

FIG. 5 illustrates one embodiment of an exemplary computer architecture.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Cloud Service Provider Introduction

The term CSP, as used herein, may refer to an enterprise that provides Infrastructure as a Service such as compute, storage and network. CSPs may also provide higher-order services such as database, messaging, search, Machine Learning, CDN, data processing, etc. Users may use the services provided by CSPs to execute workloads such as applications that run on a computer. For example, workloads may require storage and network capabilities from a CSP and may be executed across one or more CSPs using different resources available. A workload may be a traditional application hosted on a virtual machine (e.g. Cloud Provider Shape) or a Cloud Native container-based application. Each CSP may have multiple geographical locations where the physical data centers are deployed, and each such geographical location may be referred to as a cloud region for the CSP.

Within each CSP, multiple compute devices or nodes may run workloads. In some embodiments, workloads are organized into containers for execution. The term container, as used herein, may refer to an application footprint that includes the application and the required library dependencies to run. A container requires a container engine such a Docker to execute, where a Docker is a platform and tool for building, distributing, and running Docker containers. To manage and provision containerized workloads and services, the platform Kubernetes may be used to help facilitate both declarative configuration and automation. The term, Kubernetes, as used herein, is a portable, extensible, open-source platform for managing containerized workloads and services, that facilitates both declarative configuration and automation. For example, Kubernetes runs workload by placing containers into pods to run on nodes, where a node may be a virtual or physical machine and a group of nodes may be referred to as a cluster.

In one embodiment, within a CSP, multiple compute devices may communicate with each other through a VCN (virtual cloud network), which is a virtual version of physical computer network that is created and utilized within a CSP. The VCNs provide private networking, public networking and support the common networking protocols such as TCP (Transmission Control Protocol) and UDP (User Datagram Protocol). Multiple compute devices containing pods may communicate with each other across multiple clouds as well.

### Autoscaler Introduction

An autoscaler may be implemented to scale nodes up or down on an as-needed basis for a service deployment on a CSP. The autoscaler may detect the need to scale based on demand, requests from a user of a CSP, or any other mechanism. Autoscalers operating on a containerized service operate at a higher abstraction layer than the containerized service itself. For example, with respect to Kubernetes, an autoscaler acts at a higher level than a Kubernetes control plane. Usage of autoscalers contribute to cost optimization, resource usage efficiency and cost-effectiveness by providing compute for services when needed and for as long as needed by autoscaling the compute up and down on the as-needed basis.

Autoscalers also contribute to complexity reduction by allowing users to configure scaling settings by providing workload hardware requirements, like CPU architecture, networking throughput or GPU memory, instead of having to preselect concrete instance types. By specifying hardware requirements, autoscalers further contribute to resource optimization by selecting the most efficient possible instance type that matches them.

There are challenges that limit further improvements to scaling logic. One challenge lies in the split-brain effect of autoscalers acting on a higher abstraction layer, detached from the Kubernetes control-plane. Autoscalers are aware of the cloud compute offerings of CSPs, the nodes that are required for workloads, nodes that were chosen for those workloads, and nodes that are about to join the cluster. Autoscalers are also aware of a current state of a node cluster. However, while the Kubernetes control plane is aware of the current state of a node cluster, the Kubernetes control plane is not aware of the other information that autoscalers are aware of. As a result, the Kubernetes control plane can and will make decisions that do not line up with what the Autoscaler instructs. Specifically, the detachment of the Kubernetes Scheduler, which is responsible for selecting the nodes for pods, and the Autoscaler, causes these issues.

In some embodiments, it is possible to mask the problem by utilizing a node pool strategy. By creating many node pools using an autoscaler, one for each genus of pods, the Kubernetes Scheduler would be forced to place nodes from each pool to specific nodes. This can result in a lower chance of the Kubernetes Scheduler placing pods in nodes not intended by the autoscaler. However, the use of node pools reduces the cost-effectiveness impact that an Autoscaler can have, as this limits bin packing capabilities and it limits the utilization of possible cloud offerings. For example, if there is unused capacity in one node pool, a new pod that uses a different node pool but would otherwise fit into that unused capacity will require a new node added.

To further illustrate this issue, we introduce the issue of unschedulable pods. The term unschedulable pod, as used herein, may refer to a pod that is pending due to being unschedulable, meaning, there are no nodes that could fit the pod currently in the cluster. The pod might not fit anywhere due to its resource requirements or other constraints, such as node affinity. Unschedulable pods may pose optimization issues where multiple nodes are added to a service within a short range of time, on account of the Kubernetes Scheduler running its own filtering and scoring algorithms and potentially choosing a different pod distribution from what an autoscaler instructs. The issue becomes more apparent when the unschedulable pods are non-homogenous.

Consider a scenario having two unschedulable pods, including Pod 1, with capacity for 3 CPU Requests and 1 GiB of Memory Requests, and Pod 2, with capacity for 1 CPU Request and 8 GiB of Memory Requests. Consider that the autoscaler has determined to add two nodes based on an optimization algorithm for the service, including Node 1, instructed for Pod 1, where Node 1 requires a CPU Capacity of 4 and a Memory Capacity of 8, and including Node 2, instructed for Pod 2, where Node 2 requires a CPU Capacity of 2 and a Memory Capacity of 8. When these nodes join the cluster, the Kubernetes Scheduler will execute its own logic of how to place the pods into the new nodes. Moreover, the nodes will not join together immediately, as there will be a time gap. A possible result, depending on the current cluster state, of the processing sequence and the node join time is that pod2 might be scheduled on node1, leaving Pod 1 unschedulable and Node 2 empty. This scenario would require an additional node to be added, and would leave Node 1 with 3 CPU unused capacity and having wasted resources of joining Node 2 that is not sufficient to the cluster.

### Autoscaler Optimization Using “Pod Pinning” Arbiter Pod

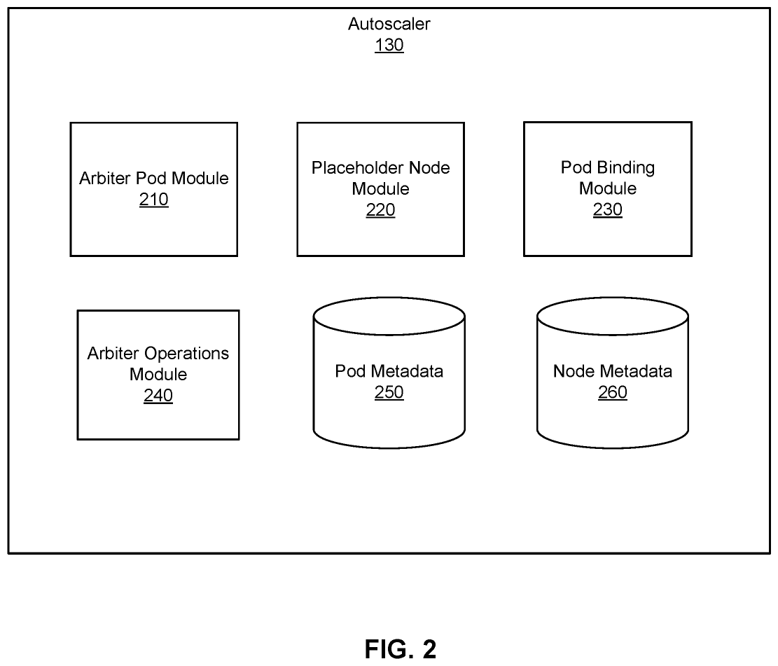

Systems and methods are disclosed herein to use an arbiter pod that performs a pod pinning operation. By pinning pods to nodes, an autoscaler may remove the Kubernetes Scheduler from the equation and prevent it from scheduling nodes in a manner inconsistent from that instructed by the autoscaler. The Kubernetes control-plane is typically private and not exposed to the Internet, whereas Autoscalers can be deployed outside of a Kubernetes cluster. Especially if the Autoscalers are utilizing multi-cluster, organizational data for machine learning purposes and other features that benefit from spanning multiple clusters. Therefore, a pod-pinning arbiter pod may be implemented inside the Kubernetes cluster that is in constant synchronization with the Autoscaler. The Pod Pinner's responsibility is to change the cluster data, namely pods and nodes, when commanded by the Autoscaler. Changing a pod's property on a pending pod means that it won't be processed by the Kubernetes Scheduler and it will now get picked up by a Kubelet to actually run the containers. Further details regarding the arbiter pod's pod pinning responsibilities are described in detail below with respect to FIGS. 2-5.

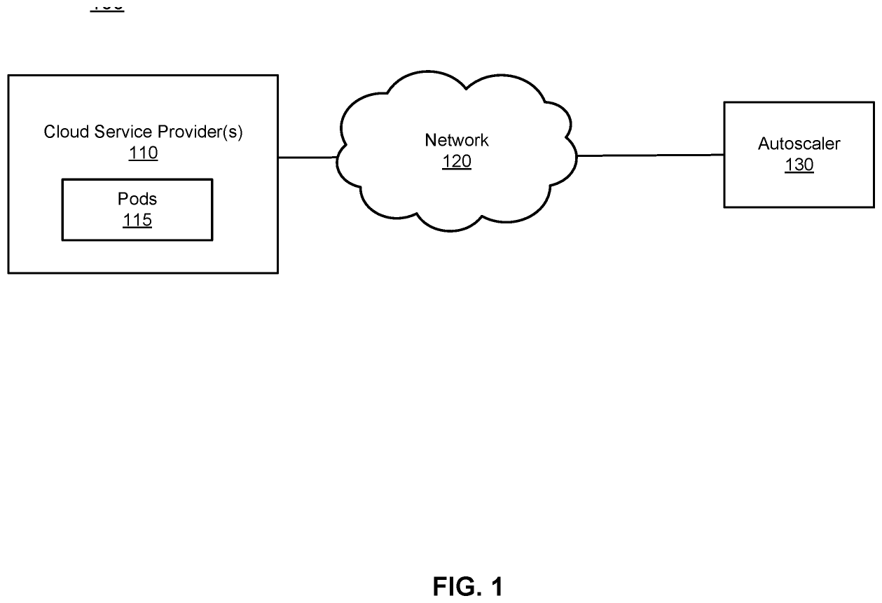

FIG. 1 illustrates one embodiment of a system environment for deploying an autoscaler. As depicted in FIG. 1, environment 100 includes cloud service provider(s) (CSP) 110 having pods 115, network 120, and autoscaler 130. CSP 110 may include any number of CSPs used to deploy a service. The CSPs deploy containerized workloads that may be distributed across pods 115. While Kubernetes is referred to throughout this disclosure, this is merely for convenience, and any containerization service may be used in place of Kubernetes.

Network 120 may be any network capable of transmitting data communications between any entity shown in FIG. 1 or described herein. Exemplary networks that network 120 may embody include the Internet, a local area network (LAN), a wide area network (WAN), a VPN (virtual private network), a VCN (virtual cloud network), a VXLAN (virtual extension local area network), Wi-Fi, Bluetooth, and any other type of network. Further disclosure of use of different CSPs to deploy pods and network configurations to deploy services in a multi-cloud environment are disclosed in commonly-owned U.S. Pat. No. 11,595,306, entitled “Executing Workloads Across Multiple Cloud Service Providers,” filed Jul. 20, 2021, granted Feb. 28, 2023, the disclosure of which is hereby incorporated by reference herein in its entirety. Autoscaler 130 performs autoscaling operations using a pod-pinning arbiter node to achieve optimization without interference by a Kubernetes scheduler. While autoscaler 130 is depicted outside of the CSP, autoscaler 130 may be deployed directly within a Kubernetes cluster within one or more CSPs. Details of activity of autoscaler 130 are provided below with respect to FIGS. 2-5.

FIG. 2 illustrates one embodiment of exemplary modules used by the autoscaler. As depicted in FIG. 2, autoscaler 130 includes arbiter pod module 210, placeholder node module 220, pod binding module 230, arbiter operations module 240, pod metadata 250, and node metadata 260. The modules and databases depicted in FIG. 2 are merely exemplary, and more or fewer modules and/or databases may be used to achieve the functionality disclosed herein.

Arbiter pod module 210 selects a pod to act as an arbiter pod for performing pod pinning of other pods. The selection may be arbitrary, random, or according to any heuristic. Arbiter pod module 210 stores an identification of the arbiter pod and an indication of its role as an arbiter pod to pod metadata 250. The arbiter pod is, for illustrative purposes, referred to herein as a Kubernetes pod, but may be any pod of any containerization service. The arbiter pod, through instructions from autoscaler 130, controls pod allocation for nodes from a plurality of candidate pods, where each of the candidate pods may be assigned to new nodes as nodes are instantiated by autoscaler 130. The arbiter pod sits on a control plane within the CSP(s) that are hosting the service. While only one arbiter pod is referenced throughout for convenience, autoscaler 130 may assign any number of arbiter pods on any basis.

When the arbiter pod is selected, the pod opens a bidirectional stream (e.g., a gRPC stream or any other protocol) between the pod and autoscaler 130. gRPC is a modern open source high performance Remote Procedure Call (RPC) framework that can run in any environment. gRPC can efficiently connect services in and across data centers with pluggable support for load balancing, tracing, health checking and authentication. gRPC is also applicable in last mile of distributed computing to connect devices, mobile applications and browsers to backend services. The bi-directional stream may facilitate real-time or near-real-time communications. Should the arbiter pod detect that the bi-directional stream is broken, the arbiter pod has instructions to reopen the bidirectional stream. The bi-directional stream may additionally or alternatively be opened by autoscaler 130.

Arbiter pod module 210 may determine that a scaling operation is to be performed (and therefore that action should be taken by the arbiter pod). This determination may be based on express instructions from a client and/or service, and/or based on artificial intelligence and/or heuristics indicative of demand for deploying a service requiring that resources for the service be scaled. The scaling can be up or down, but in the description that follows a scenario where scaling up is performed is described. For example, arbiter pod module 210 may determine that a scaling operation is to be performed by automatically detecting that an existing operation has experienced a load demand that requires one or more additional nodes. When scaling up, autoscaler 130 may determine a set of nodes that are optimized for the scaling operation based on the types of nodes offered by the CSP(s) hosting the service. Node capabilities may be stored in node metadata 260 based on discovery operations to determine node capabilities, which may be referenced by autoscaler 130 to determine which nodes to use and their characteristics and requirements.

Arbiter pod module 210 acts to send instructions from the autoscaler 130 to the arbiter pod within the Kubernetes control plane. For a set of nodes that are to be deployed in connection with a scaling operation, arbiter pod module 210 may determine an optimal set of pods to use to effect each node of the set of nodes. Arbiter pod module 210 may issue instructions to the arbiter pod to pin each respective pod to its respective node to ensure that pods are optimally allocated to nodes. Arbiter pod module 210 may store to pod metadata 250 and/or node metadata 260 an indication of pod-to-node assignments. Pod pinning is important because there is a lag time between when nodes are instructed to be created and when they are actually provisioned and able to link with pods. Without the pod pinning operations disclosed herein, a Kubernetes scheduler could detect the unassigned pods and assign them to other nodes to satisfy other requests or otherwise perform cleanup on the unassigned pods.

In order to ensure that the Kubernetes scheduler does not incorrectly reassign or otherwise clean up a given pod that is already spoken for while a given node is being instantiated, placeholder node module 220 instructs the arbiter pod to generate a placeholder node while an assigned node is instantiated and to attach the corresponding pod to the placeholder node. The goal here is to notify the arbiter pod of which pod has to go onto which new node. The node placeholder is used in the interim because of Kubernetes limitations. For example, when the arbiter pod binds a pod to a node, this act sets a value on the node with a specific node name (or other identity metadata), but if that node does not yet exist because it is in the process of being provisioned, then the pod will be cleaned up because the control plane would see this is bound to a node that doesn't exist and will clean it up during garbage collection. Binding the pod to the placeholder is to be performed as quickly as possible in order to occur before garbage collection by the Kubernetes control plane (e.g., hence the real-time or near-real-time bi-directional communications channel). The result therefore is that the placeholder node is instantiated and its corresponding pods are bound in a timeframe that is faster than the assigned node being instantiated. Pod binding module 230 instructs the arbiter pod to bind pods selected by the autoscaler 130 to the given placeholder node.

The instructions for generating the placeholder node include identifying information for the actual node that will be instantiated. Placeholder node module 220 may send a create node placeholder message sends data for the node resources that will be supported when the node joins the clusters. The placeholder node is an actual node resource, but without an actual compute instance yet backing it up in the real world. That is, the placeholder is just data showing a node name (or other identity metadata) of the eventual node and its purpose is to just stop control plane from garbage collection. The term identity metadata, as used herein, may include data that uniquely identifies a node, such as name or any other unique identifier.

In some embodiments, after the placeholder node is created and bound to its respective pod(s), the bound pods enrich the placeholder node with resources to provision it into a full-fledged node capable of performing its designated functions and having the specifications assigned by the autoscaler 130. In some embodiments, the node is provisioned separately from the placeholder node. In such embodiments, when the node is provisioned, pods that were bound to the placeholder node are cleared and reassigned to the provisioned node. This may be performed by way of reassignment, or by instructing deletion, recreation, and binding of those pods to the provisioned node. An instruction is made to clear the placeholder node as well, as it has a name in conflict with the provisioned node and should therefore be deleted.

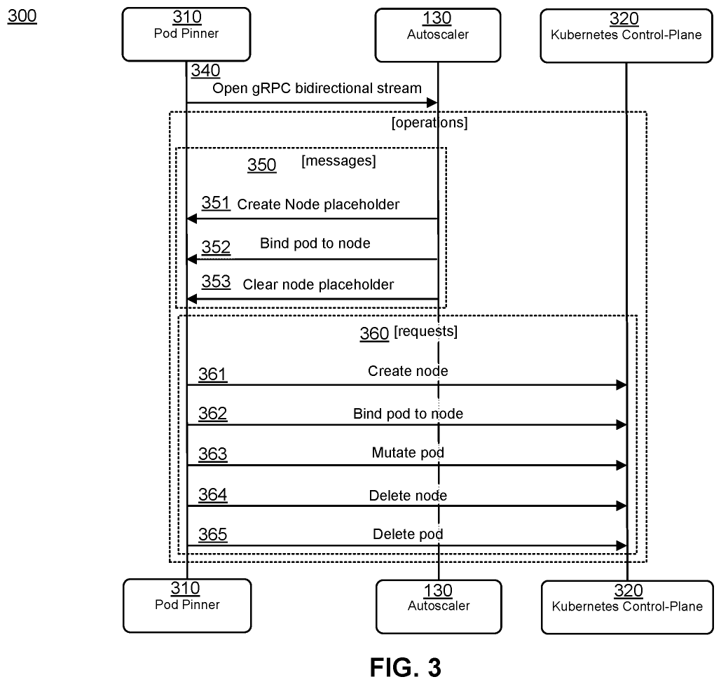

Arbiter operations module 240 performs various operations in coordination with the arbiter pod (e.g., after the node is instantiated and fully provisioned with its corresponding pods). Turning briefly to FIG. 3 to illustrate, FIG. 3 illustrates one embodiment of a swim lane diagram showing activities taken by the autoscaler and an arbiter pod. Flow diagram 300 depicts interactions between pod pinner 310, autoscaler 130, and control plane 320. Pod pinner 310 is the arbiter node performing pod pinning actions. The first phase occurs where pod pinner 310 opens 340 a bi-directional stream (e.g., gRPC). This may occur based on instructions from autoscaler 130 to open a bi-directional stream following selection or recreation of the arbiter node.

Through the open bi-directional stream, autoscaler 130 may provide instructions to pod pinner 310 to perform operations that facilitate scaling operations. In particular, the instructions may be in service of provisioning 350 new nodes. Autoscaler 130 first determines (not depicted) the properties of the nodes that it is provisioning, and optimally maps pods and their capabilities to the requirements of the nodes (e.g., referencing pod metadata 250 and node metadata 260). Having selected what node to provision and which pods to map to the node, autoscaler 130 instructs 351 pod pinner 310 to create a node placeholder. The pod pinner 310 first binds the matched pods to the node placeholder so that the pods are not cleaned up by the Kubernetes scheduler. When the node is created, autoscaler 130 instructs 352 the pod pinner 310 to bind the pods to the node (rather than the placeholder node), and then instructs 353 the pod pinner 310 to clear the node placeholder.

In order to effect the instructions received from autoscaler 130, pod pinner 310 may perform various requests 360. Create node request 361 is a request from pod pinner 310 to create a node having specifications instructed from autoscaler 130 (e.g., a certain amount of CPU and/or memory). Create node request 361 may also be used to create a placeholder node having the identification information of the ultimate node to be created.

Bind pod to node request 362 is a request from the pod pinner to bind a given pod to a particular node, and is used to bind, within the Kubernetes control plane, a node to a placeholder or real node based on instructions from autoscaler 130.

Mutate pod request 363 is a request to mutate a pod from its default configuration. For example, where a pod is to be bound upon creation, a mutate pod request 363 may be made to mutate the pod to be bound at the time of creation, rather than being created and by default assignable to be bound to any node by the Kubernetes scheduler. Mutate pod request 363 may be performed using an admission webhook. Admission webhooks are HTTP callbacks that receive admission requests and do something with them. Admission webhooks may be either validating admission webhooks or mutating admission webhooks. Mutating admission webhooks are invoked first, and can modify objects sent to the API server to enforce custom defaults. After all object modifications are complete, and after the incoming object is validated by the API server, validating admission webhooks are invoked and can reject requests to enforce custom policies.

Delete node request 364 is used to delete nodes based on instructions to do so received from autoscaler 130. For example, when placeholder nodes are to be deleted or when operations are to be scaled down, pod pinner 310 may issue a delete node request 364 to Kubernetes control plane 320. Delete pod request 365 is similarly used to delete pods based on instructions to do so received from autoscaler 130. Each of requests 360 may be application programming interface (API) calls to the Kubernetes control plane 320.

In some embodiments, delete node request 364 is used in scenarios where a node fails to initialize after a pod is bound to the node. Autoscaler 130 may determine based on, e.g., the state of the Kubernetes and cloud data it has access to, that the node failed to be created. Autoscaler 130 may transmit instructions to the pod pinner that the placeholder node to which a pod is bound should be cleared. Responsively, pod pinner 310 may issue a delete node request 364. This may occur in tandem with instructions from autoscaler 130 to recreate the placeholder node. This occurs because to cure the error of the node failing to be created, the node (and placeholder therefor) may be recreated, resulting in different identifiers being generated for the recreated node relative to identifiers for the placeholder node that failed to be created. Because binding pods to a node is an immutable action, autoscaler 130 clears the state be deleting the node, deleting the pod, and then creates a placeholder node anew and recreates the pods to be assigned to that placeholder node (e.g., using a mutate pod request 363 with a webhook to monitor for recreation of the pod and responsive assignment to the placeholder node).

Returning to FIG. 2, arbiter operations module 240 may perform any of the operations of FIG. 3 to perform the instructions received from autoscaler 130. Combinations of functions may be needed to effect instructions. For example, pod pinner 310 cannot bind all pods just by using a simple bind pod to node request 362, because pods might get recreated and those pods need to be secured to avoid the Kubernetes scheduler assigning them to the wrong node. Therefore, arbiter operations module 240 may instruct the pod pinner 310 to mutate pods in this scenario on creation.

As another example, the autoscaler 130 might decide that a certain node has to be recreated and split into two nodes since it may be a more efficient allocation of resources. When autoscaler 130 instructs to replace that node, all pods assigned to that node might get recreated. In those instances, if pods get recreated and they do not have node name in their specifications, those pods might get scheduled somewhere else breaking the assignments predetermined by autoscaler 130. To ensure correct allocation, autoscaler 130 instructs the pod pinner 310 of what those new nodes will be. Arbiter operations module 240 may with those instructions perform various requests including binding, mutation, and creation in order to ensure that the pods are allocated to the correct new node(s).

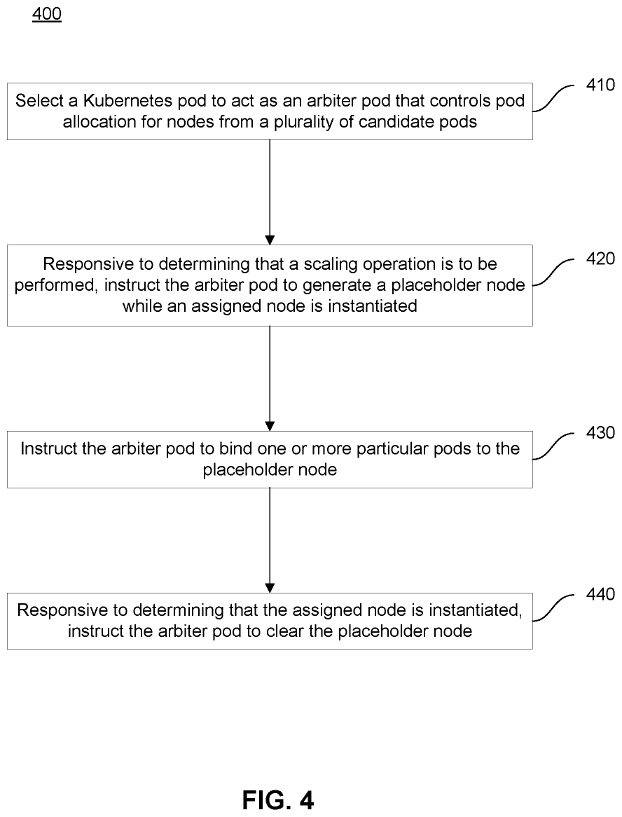

FIG. 4 illustrates an exemplary flowchart for activities performed by the autoscaler in optimally provisioning pods to nodes. Process 400 may be performed by one or more processors executing instructions that cause the modules of autoscaler 130 to perform operations. Process 400 may begin with autoscaler 130 selecting 410 a Kubernetes pod to act as an arbiter pod that controls pod allocation for nodes from a plurality of candidate pods (e.g., using arbiter pod module 210). Responsive to determining that a scaling operation is to be performed, autoscaler 130 may instruct 420 the arbiter pod to generate a placeholder node while an assigned node is instantiated (e.g., using placeholder node module 220). Autoscaler 130 may instruct 430 the arbiter pod to bind one or more particular pods to the placeholder node (e.g., using pod binding module 230). Responsive to determining that the assigned node is instantiated, autoscaler 130 may instruct 440 the arbiter pod to clear the placeholder node (e.g., using arbiter operations module 240).

### Exemplary Pod Pinner Activity

As described in the foregoing, it is crucial to keep the cluster state clean and operational when something goes wrong with a pod pinning operation. That is, pods and nodes involved in a failure, such as a node creation failure, are to be drained and deleted in such failure events. An example situation mentioned above is where a node placeholder is created and pods are pinned to it, but a failure occurs and the real node never joins the cluster-leaving the pods pinned to a non-existing node. This situation can lead to outages, underutilization of resources, scaling limitations, dependency failure cascades and so on.

To solve such a scenario, autoscaler 130 may keep track of the nodes it asks to create and the pods pinned to those nodes (e.g., using pod metadata 250 and node metadata 260). In case of a node creation failure, autoscaler 130 instructs the arbiter node to remove the respective node placeholder. When this happens, the autoscaler 130 also ensures that pinned pods are recreated and have to get pinned again, as if this does not occur, the Kubernetes Scheduler will take over and schedule the pods where it thinks is the best.

An exemplary procedure for this solution is as follows. Autoscaler 130 instructs the arbiter node to pin certain pods to new nodes before removing the old node placeholder and making the pods unscheduled. Autoscaler 130 accomplishes this by sending a “Create node placeholder A” action to the pod pinner 310, resulting in pod pinner 310 performing a request to the Kubernetes control plane to create a node placeholder. The node placeholder A is created and the pods are pinned to this node placeholder A.

A Notification Mechanism tells autoscaler 130 that the real node A failed to get created and it will not join the cluster. Autoscaler 130 determines to create a different node (B) and instructs the pod pinner 310 to create a node placeholder for it. Pod pinner 310 performs a request to the Kubernetes control plane to create the placeholder B. The node placeholder is created B and the Notification Mechanism communicates to autoscaler 130 an indication that the node B has been created and that node B joined the cluster.

Autoscaler 130 determines that the previous node A was not successfully created and the pods are still pinned to it. Autoscaler 130 creates a “delete node placeholder” action for placeholder A. Additionally, autoscaler 130 creates “pin pod on creation to placeholder B” actions for the pods that are pinned to the placeholder A (e.g., using a mutate pod request 363). This action occurs because when the placeholder A gets removed, the pinned pods are recreated. Autoscaler 130 may send these instructions sequentially or in a bundle to pod pinner 310.

Pod pinner 310 deletes the node placeholder A. The pods are recreated. Pod pinner 310 sees that it has “pin pod on creation to placeholder B” actions for the previously pinned pods and binds them to the node B.

This technique allows the combination of Autoscaler and Pod Pinner to fully disregard the Kubernetes Scheduler even in situations when nodes fail to get created and join the cluster.

### Computing Machine Architecture

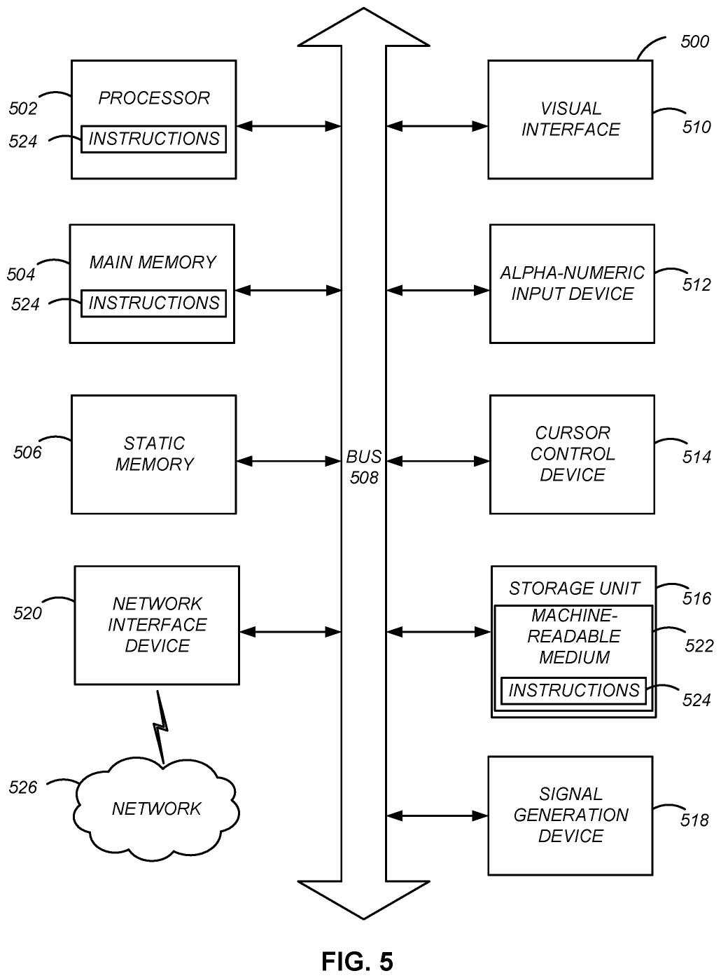

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500 within which program code (e.g., software) for causing the machine to perform any one or more of the methodologies discussed herein may be executed. The program code may be comprised of instructions 524 executable by one or more processors 502. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include visual display interface 510. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 510 may include or may interface with a touch enabled screen. The computer system 500 may also include alphanumeric input device 512 (e.g., a keyboard or touch screen keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

### ADDITIONAL CONFIGURATION CONSIDERATIONS

Implementing pod pinning, the solution for the detached decision flows of the Kubernetes control plane and the Autoscaler, is non-trivial. Challenges lie in the distributed nature of the solution and enabling near real-time communication between the components. In terms of near real-time communication, autoscaler decisions need to be communicated to the pod pinner as fast as possible. The aim is to either decrease or at least have no impact on the time it takes for a pending pod to transition into a running state. While pods are pending, the pods are not doing any work, which can translate into various operational issues, like application not being able to withstand the incoming traffic. The systems and methods disclosed herein optimally allocate pods to nodes while minimizing idle time of those pods.

While a node is in-progress of joining the cluster, various operations occur such as compute instances are being created, kubelet is initializing, etc. During this time, the pod pinner can work on creating the node placeholders and binding pods to those placeholders. Nodes can join the cluster in seconds, so the communication between components has to be near real-time. Furthermore, the Pod Pinner translates messages received from the Autoscaler to requests for the Kubernetes control-plane immediately after receival, further facilitating near real-time communications.

The Kubernetes Scheduler, the Autoscaler, the nodes and the pods are all separate systems which have their own execution flows, can fail, need to be retried and have to be coordinated. The systems and methods disclosed herein orchestrate activity of such systems in a manner that enables pod pinning to occur. For example, for the Kubernetes Scheduler to not affect the decisions of the Autoscaler, a node placeholder must be created and the pods must be bound to it. If the node placeholder is not created and pods are bound to a non-existent node, the pods then are treated as garbage and will be removed, failing the pod pinning process. Moreover, if the node joins faster than the pod pinner is able to bind pods to the node, then the Kubernetes Scheduler might execute its scheduling logic for the pod and place it somewhere where the Autoscaler didn't intend it to be placed, potentially resulting in unschedulable pods. The systems and methods disclosed herein prevent such unschedulable pods from occurring. Moreover, without using pod pinning, problems beyond unschedulable pods may occur, including inefficient allocation due to resource usage inefficiencies, resource fragmentation and inefficient pod placement, and potential application downtime due to increased pod scheduling duration.

Nodes can fail to join a cluster for various reasons. If the pod pinner already performed the actions of creating a node placeholder, binding pods to that placeholder, and so on, then it needs to clean everything up because the node names are based on cloud compute instance IDs, and those IDs are different when the node creation is retried. The systems and methods disclosed herein enable cleanup to address node failures.

The Pod Pinner component itself can get terminated due to various reasons. Therefore, the pod pinner must participate in the process of tracking what messages were consumed and which messages need to be redelivered. Moreover, network issues might arise and certain messages might become obsolete. For example, if the Pod Pinner is experiencing issues connecting to the Autoscaler, or where a node has joined the cluster and already has pods running on it, meaning that creating the node placeholder and binding pods to it will fail if attempted. Tracking pod metadata 250 and node metadata enables the systems and methods disclosed herein to avoid these issues.

Autoscalers usually act on clearly defined triggers when adding nodes, such as unschedulable pods, predictive models, and so on. Pod pinning as disclosed herein introduces complexity into these triggers, because the process of pod pinning requires an Autoscaler to track the state of the relationship between new nodes and pods, i.e., which nodes were meant for which pods, s well as whether a node needs to be retried (where if so, the process of clearing the node placeholder will have to be triggered and all pods bound to it will have to be rebound to another node placeholder). The autoscaler, as disclosed herein, is enabled to act as necessary by participating in the process of tracking what messages were consumed by the Pod Pinner and what messages need to be redelivered.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for benchmarking, grouping, and recommending CSP shapes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
selecting a pod to act as an arbiter pod that controls pod allocation for nodes from a plurality of candidate pods;
responsive to determining that a scaling operation is to be performed, instructing the arbiter pod to generate a placeholder node while an assigned node is instantiated;
instructing the arbiter pod to bind one or more particular pods to the placeholder node; and
responsive to determining that the assigned node is instantiated, instructing the arbiter pod to clear the placeholder node.

2. The method of claim 1, wherein instructing the arbiter pod to generate the placeholder node comprises indicating identity metadata for the assigned node to be used by the placeholder while the assigned node is instantiated.

3. The method of claim 1, wherein the scaling operation defines resources to be allocated to the assigned node.

4. The method of claim 3, wherein the one or more particular pods are selected for binding to the placeholder node based on an optimization of capacity of the one or more particular pods relative to the resources to be allocated to the assigned node.

5. The method of claim 1, wherein binding the one or more particular pods to the placeholder nodes while the assigned node is instantiated prevents cleanup of the one or more particular pods by a Kubernetes control plane.

6. The method of claim 1, wherein the arbiter pod executes on instructions by making application programming interface (API) calls to a Kubernetes control plane that effect generate, bind, and clear instructions.

7. The method of claim 6, wherein the arbiter pod is within the Kubernetes control plane.

8. The method of claim 7, wherein the arbiter pod receives instructions from an entity acting outside of the Kubernetes control plane.

9. The method of claim 1, wherein the placeholder node is instantiated and the one or more particular pods are bound in a timeframe that is faster than the assigned node being instantiated.

10. The method of claim 1, wherein determining that a scaling operation is to be performed comprises automatically detecting that an existing operation has experienced a load demand that requires one or more additional nodes.

11. The method of claim 1, wherein the assigned node was previously instantiated, and wherein the method further comprises:
instructing the arbiter pod to drain the one or more particular pods; and
instructing the arbiter pod to monitor for re-creation of the one or more particular pods using a webhook, wherein the arbiter pod, upon detecting re-creation of the one or more particular pods, pins the one or more particular pods to the assigned node upon re-creation.

12. The method of claim 1, wherein pod is a Kubernetes pod.

13. A non-transitory computer-readable medium comprising memory with instructions thereon that, when executed by one or more processors, cause the one or more processors to perform operations, the instructions comprising instructions to:
select a pod to act as an arbiter pod that controls pod allocation for nodes from a plurality of candidate pods;
responsive to determining that a scaling operation is to be performed, instruct the arbiter pod to generate a placeholder node while an assigned node is instantiated;
instruct the arbiter pod to bind one or more particular pods to the placeholder node; and
responsive to determining that the assigned node is instantiated, instruct the arbiter pod to clear the placeholder node.

14. The non-transitory computer-readable medium of claim 13, wherein the instructions to instruct the arbiter pod to generate the placeholder node comprise instructions to indicate identity metadata for the assigned node to be used by the placeholder while the assigned node is instantiated.

15. The non-transitory computer-readable medium of claim 13, wherein the scaling operation defines resources to be allocated to the assigned node.

16. The non-transitory computer-readable medium of claim 15, wherein the one or more particular pods are selected for binding to the placeholder node based on an optimization of capacity of the one or more particular pods relative to the resources to be allocated to the assigned node.

17. The non-transitory computer-readable medium of claim 13, wherein binding the one or more particular pods to the placeholder nodes while the assigned node is instantiated prevents cleanup of the one or more particular pods by a Kubernetes control plane.

18. The non-transitory computer-readable medium of claim 13, wherein the arbiter pod executes on instructions by making application programming interface (API) calls to a Kubernetes control plane that effect generate, bind, and clear instructions.

19. The non-transitory computer-readable medium of claim 18, wherein the arbiter pod is within the Kubernetes control plane.

20. A system comprising:
a non-transitory computer-readable medium comprising memory with instructions encoded thereon; and
one or more processors that, when executing the instructions, are caused to perform operations comprising:
selecting a pod to act as an arbiter pod that controls pod allocation for nodes from a plurality of candidate pods;
responsive to determining that a scaling operation is to be performed, instructing the arbiter pod to generate a placeholder node while an assigned node is instantiated;
instructing the arbiter pod to bind one or more particular pods to the placeholder node; and
responsive to determining that the assigned node is instantiated, instructing the arbiter pod to clear the placeholder node.
